(19) United States
(12) Patent Application Publication
(10) Pub. No.: US 2021/0217074 A1
(43) Pub. Date: Jul. 15, 2021

(54) SYSTEMS AND METHODS FOR PROVIDING A STYLE RECOMMENDATION

(71) Applicant: MKM GLOBAL PTY LTD., Woollahra (AU)

(72) Inventors: Richard John MATTHEWMAN, Woollahra (AU); Richard Mathieson KAVANAGH, Rose Bay (AU); David MANNAH, Forest Lodge (AU)

(73) Assignee: MKM Global Pty Ltd., Woollahra (AU)

(21) Appl. No.: 17/054,837

(22) PCT Filed: May 16, 2019
(86) PCT No.: PCT/IB2019/000584

§ 371 Date: Nov. 12, 2020

Related U.S. Application Data
(60) Provisional application No. 62/672,258, filed on May 16, 2018.

(51) Int. Cl. G06Q 30/06; A45D 44/00; G06F 16/535; G06K 9/00

(52) U.S. Cl. CPC G06Q 30/0631; A45D 44/005; G06Q 30/0629; A45D 2044/007; G06K 9/00288; G06K 9/00241; G06F 16/535

(57) ABSTRACT

The disclosed embodiments include systems, devices, and methods to produce style recommendations. The systems, devices, and methods may include a memory device storing a set of instructions and at least one processor executing the set of instructions to perform a method. The systems and devices may be configured to produce at least one style recommendation based on received user data and stored styling data. The systems and devices may further be configured to display an image representing the at least one style recommendation on at least one of a tablet and/or a smart mirror.

### CROSS-REFERENCE TO RELATED APPLICATIONS

This application claims priority under 35 U.S.C. § 119 to U.S. Provisional Application No. 62/672,258, filed on May 16, 2018, which is expressly incorporated herein by reference in its entirety.

### TECHNICAL FIELD

The disclosed embodiments generally relate to systems and methods for providing a style recommendation and, more particularly, to systems and methods using a smart mirror device.

### BACKGROUND

There exists various methods for stylists to provide hair consultations to their clients. For example, many stylists ask their clients which style they would prefer and sometimes recommend take home haircare or styling. However, this method is less than ideal because clients cannot predict how they will look or if they will be satisfied with new styles and, therefore, they have little incentive to try new styles recommended by their stylists.

In another method, clients may simply ask for the same style they were given at an earlier appointment. But, even if the client has a reference picture of their style from their last appointment, this method is deficient because it is inaccurate with respect to duplicating the client's style. A single stylist could have hundreds of appointments in between a single client's consecutive appointments and relying on a picture is infeasible. This deficient method results in the stylist unable to treat the client's hair to their desired length, color, and texture.

As disclosed herein, stylists may use smart mirrors and augmented reality technology to project a desired style on a client before the client commits to the style. Using a smart mirror and augmented reality alone, however, may still be deficient if it relies solely on the subjective suggestion of the stylist or the client, which could lead to the client having little incentive to commit to new styles. In fact, only 7% of clients feel they have ever received a thorough consultation from their stylist, 93% of clients are not recommended any take home haircare or styling, and 83% of clients would purchase take home haircare or styling if recommended by their stylist. In contrast, 95% of hairstylists feel they give their clients a thorough consultation.

Therefore, there exists a need to provide accurate and thorough style consultations to clients.

### SUMMARY

Consistent with disclosed embodiments, systems, methods, and computer-readable media are presented for providing style recommendations.

Consistent with a disclosed embodiment, a system for providing style recommendations is disclosed. The system may include a memory device storing a set of instructions and at least one processor executing the set of instructions to perform a method. The method may comprise receiving user data describing a user, where the user data includes at least one of a selection of images from a provided image set, social media data, or facial recognition data; comparing the user data to stored styling data; determining that the user data matches the stored styling data; outputting at least one style recommendation based on the matching stored styling data; and displaying an image representing the at least one style recommendation on a display.

Consistent with another embodiment, a smart mirror device for producing style recommendations is provided. The device may include a mirror unit the mirror unit comprising a mirror; a lighting system configured to provide consistent lighting for capturing an image of a user's face; and a camera at a location on the mirror unit; and a tablet connected to the mirror unit.

Consistent with another embodiment, a method for providing at least one style recommendation is provided. The method may include receiving user data describing a user, where the user data includes at least one of a selection of images from a provided image set, social media data, or facial recognition data; comparing the user data to stored styling data; determining that the user data matches the stored styling data; outputting at least one style recommendation based on the matching stored styling data; and displaying an image representing the at least one style recommendation on a display.

Consistent with another embodiment, a non-transitory computer-readable medium having stored instructions, which when executed, cause a processor to provide at least one style recommendation is provided. The instructions may include receiving user data describing a user, where the user data includes at least one of a selection of images from a provided image set, social media data, or facial recognition data; comparing the user data to stored styling data; determining that the user data matches the stored styling data; outputting at least one style recommendation based on the matching stored styling data; and displaying an image representing the at least one style recommendation on a display.

It is to be understood that both the foregoing general description and the following detailed description are exemplary and explanatory only and are not restrictive of the disclosed embodiments, as claimed.

### BRIEF DESCRIPTION OF DRAWINGS

The accompanying drawings, which are incorporated in and constitute a part of this specification, illustrate the disclosed embodiments, and together with the description, serve to explain the disclosed embodiments. In the drawings:

FIGS. 1 and 2 are block diagrams of an exemplary system, consistent with disclosed embodiments;

FIG. 3 is a block diagram of an exemplary server, consistent with disclosed embodiments;

FIG. 4 is a block diagram of an exemplary mirror, consistent with disclosed embodiments;

FIG. 5 is a block diagram of an exemplary tablet, consistent with disclosed embodiments;

FIG. 6 is a flowchart of an exemplary process for providing at least one style recommendation, consistent with disclosed embodiments;

FIGS. 7-23 are illustrations of an exemplary system at different points of the flowchart of FIG. 6, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Disclosed embodiments include systems and methods for providing style recommendations. The systems and methods include various features that allow a user, such as a client of a stylist, to provide user data that may be compared to stored styling data to provide at least one style recommendation. For example, a system may determine that a style recommendation is best suited for the client by comparing the user data provided by the client to stored styling data and determining that the user data matches the stored styling data. Similarly, a device may accurately capture one example of user data by using a mirror, lighting system, and camera.

For example, the client may be prompted to provide answers to questions using images as a guide, where the client's answers indicate a specific personality type.

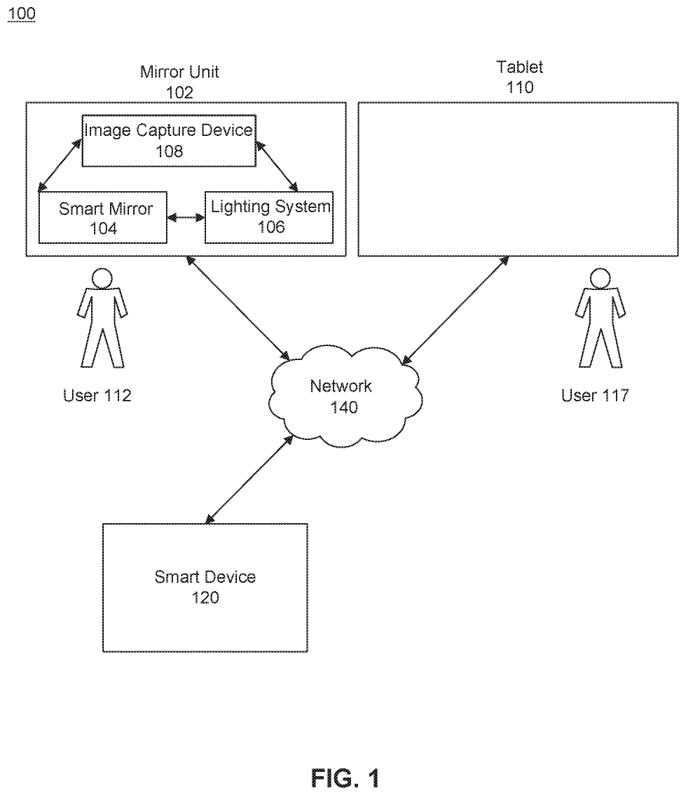

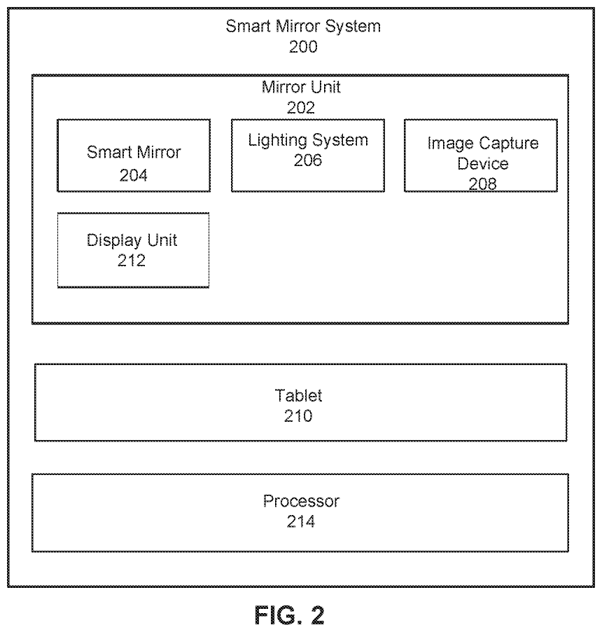

FIGS. 1 and 2 are block diagrams illustrating an exemplary smart mirror system 100, 200 for performing one or more operations consistent with the disclosed embodiments. In one embodiment, smart mirror system 100, 200 may include a mirror unit 102, 202 and a tablet 110, 210. In some embodiments, the tablet 110, 210 may be any smart device configured to communicate with the smart mirror 104, 204. In some embodiments, the tablet, 110, 210 may be special purpose device physically tethered to the smart mirror 104, 204.

Components of smart mirror system 100, 200 may be computing systems configured to process user data to provide a style recommendation. As further described herein, components of system 100, 200 may include one or more computing devices (e.g., computer(s), server(s), embedded systems etc.), memory storing data and/or software instructions (e.g., database(s), memory devices, etc.), etc. In some embodiments, one or more computing devices may be configured to execute software instructions stored on one or more memory devices to perform one or more operations consistent with the disclosed embodiments. Components of system 100, 200 may be configured to communicate with one or more other components of system 100, 200, including mirror unit 102, 202, tablet 110, 210, and a smart device 120. In some embodiments, smart device 120 may be any smart device configured to communicate with mirror unit 102, 202 and/or tablet 110, 210. For example, smart device 120 may belong to a user 117 who may be a client. In certain aspects, users may operate one or more components of system 100, 200 to initiate one or more operations consistent with the disclosed embodiments. For example, mirror unit 102, 202 may be operated by a user 112. User 112 may be a stylist and/or a client. User 117 may be similarly associated with tablet 110, 210.

Tablet 110, 210 may be one or more computing devices configured to execute software instructions for performing one or more operations consistent with the disclosed embodiments. In some embodiments, tablet 110, 210 may be configured to receive input from user 112 or user 117. In some aspects, tablet 110, 210 may receive input from user 112 or user 117 through an I/O device, such as a touch screen. Tablet 110, 210 may include an image capture device 108, 208, such as a camera or other lens device, configured to capture an image as data. The image data may be associated with an instantaneous picture, a sequence of pictures, a continuous stream of images (e.g., video), etc.

Mirror unit 102, 202 may be one or more computing devices, including processor 214, configured to execute software instructions for performing one or more operations consistent with the disclosed embodiments. In an exemplary embodiment, mirror unit 102, 202 may include a smart mirror 104, 204. Mirror unit 102, 202 may include a display unit 112, 212 to display various images. In some embodiments, smart mirror 104, 204 may be configured to receive input from user 112 or user 117. In some respects, smart mirror 104, 204 may receive input from user 112 or user 117 through an I/O device, such as a touch screen. In other aspects, smart mirror 104, 204 may receive input from user 112 or user 117 through an I/O device, such as a touch screen of tablet 110, 210.

Mirror unit 102, 202 may further include a lighting system 106, 206 that includes sensors configured to receive at least one environmental light signal and adjust the brightness of lighting system 106, 206 according to the received environmental light signal. Lighting system 106, 206 may be permanently fixed. This may provide the advantage of providing a consistent and repeatable lighting for imaging. This may reduce processing and/or reduce user error that may be introduced by configuring the imaging for lighting.

Mirror unit 102, 202 may further include an image capture device 108, 208, such as a camera or other imaging device, configured to capture an image as data. Lighting system 106, 206 may be configured to optimize lighting based on a fixed position of the image capture device 108, 208. The image data may be associated with an instantaneous picture, a sequence of pictures, a continuous stream of images (e.g., video), etc. In some embodiments, image capture device 108, 208 may be configured to receive input from user 112 or user 117. In some aspects, the received input may include facial features of the user, such as the user's face shape, skin tone, and eye color. In other aspects, the received input may also include hair characteristics of the user, such as the user's hair length, hair color, hair texture, and hair style.

Lighting system 106, 206 may receive data from image capture device 108, 208 as input data. The sensors of lighting system 106, 206 may be configured to compare the received environmental light signal(s) to the received data from image capture device 108, 208, determine the brightness that will result in the optimum image quality and highest accuracy in determining the user's facial features and hair characteristics, and adjust the brightness according to the determination.

Image capture device 108, 208 may receive data from lighting system 106, 206 indicating that the adjustment is complete and image capture device 108, 208 may, accordingly, automatically capture and store at least one image of the user. Smart mirror 104, 204 and tablet 110, 210 may receive data from lighting system 106, 206 indicating that the adjustment is complete and smart mirror 104, 204 and tablet 110, 210 may, accordingly display a prompt indicating that at least one image may be captured and stored. Any user may use the touch screen of smart mirror 104, 204 or tablet 110, 210 to select an option to capture at least one image and store the at least one image.

In any of the embodiments of the disclosure, at least one of smart mirror 104, 204 or tablet 110, 210 may be configured to send and receive data to each other (e.g., via WiFi, Bluetooth®, cable, etc.) via network 140 to execute any of the processes of the disclosure. In other embodiments, the smart mirror device 104, 204 may be tethered via a wire to the tablet 110, 210. The wire may limit the ability of tablet 110, 210 to be detached from the smart mirror 104, 204. This may be either through a permanent mounting or some form of tamper proof means of detaching the tether (e.g., a lock, requiring a specialized tool, etc.). The tether may allow processing to be offloaded from tablet 110, 210 to smart mirror 104, 204. For example, tablet 110, 210 may provide basic functionality to display information provided by smart mirror 104, 204 and transmit user selections back to smart mirror 104, 204. Smart mirror 104, 204 may then execute the processes described herein.

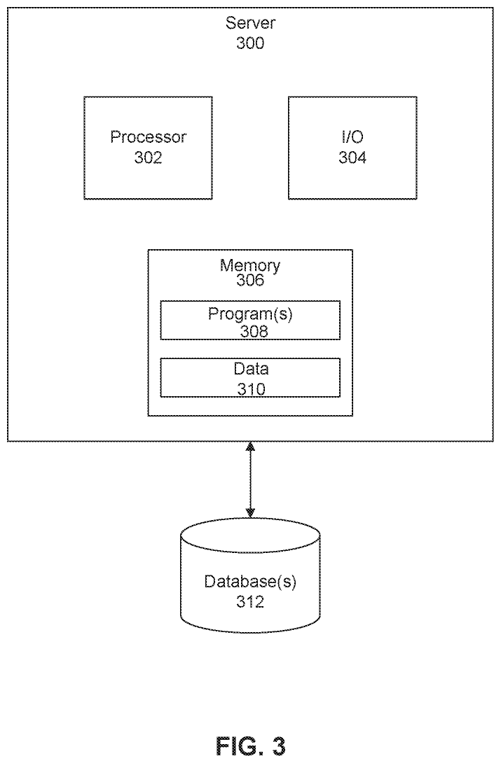

FIG. 3 shows an exemplary server 300 for implementing embodiments consistent with the present disclosure. In an exemplary embodiment, server 300 may correspond to mirror unit 102, 202. However, variations of server 300 may correspond to smart mirror 104, 204, lighting system 106, 206, image capture device 108, 208, tablet 110, 210 and/or components thereof.

In one embodiment, server 300 may include one or more processors 302, one or more memories 306, and one or more input/output (I/O) devices 304. According to some embodiments, server 300 may be an embedded system or similar computing devices that generate, maintain, and provide web site(s) consistent with disclosed embodiments. Server 300 may be standalone, or it may be part of a subsystem, which may be part of a larger system. For example, server 300 may represent distributed servers that are remotely located and communicate over a network (e.g., network 140) or a dedicated network, such as a LAN. Server 300 may correspond to any of smart mirror 104, 204, lighting system 106, 206, image capture device 108, 208, or tablet 110, 210. The disclosed embodiments are not limited to any type of processor(s) configured in server 300.

Memory 306 may include one or more storage devices configured to store instructions used by processor 302 to perform functions related to disclosed embodiments. For example, memory 306 may be configured with one or more software instructions, such as program(s) 308 that may perform one or more operations when executed by processor 302. The disclosed embodiments are not limited to separate programs or computers configured to perform dedicated tasks. For example, memory 306 may include a single program 308 that performs the functions of the server 300, or program 308 could comprise multiple programs. Additionally, processor 302 may execute one or more programs located remotely from server 300. For example, smart mirror 104, 204, lighting system 106, 206, image capture device 108, 208, and/or tablet 110, 210, may, via server 300, access one or more remote programs that, when executed, perform functions related to certain disclosed embodiments. Memory 306 may also store data 310 that may reflect any type of information in any format that the system may use to perform operations consistent with the disclosed embodiments.

I/O devices 304 may be one or more devices configured to allow data to be received and/or transmitted by server 300. I/O devices 304 may include one or more digital and/or analog communication devices that allow server 300 to communicate with other machines and devices, such as other components of system 100, 200.

Server 300 may also be communicatively connected to one or more database(s) 312. Server 300 may be communicatively connected to database(s) 312 through network 140. Database 312 may include one or more memory devices that store information and are accessed and/or managed through server 300. The databases or other files may include, for example, data and information related to the source and destination of a network request, the data contained in the request, etc. Systems and methods of disclosed embodiments, however, are not limited to separate databases. In one aspect, system 100, 200 may include database 312. Alternatively, database 312 may be located remotely from the system 100, 200. Database 312 may include computing components (e.g., database management system, database server, etc.) configured to receive and process requests for data stored in memory devices of database(s) 312 and to provide data from database 312.

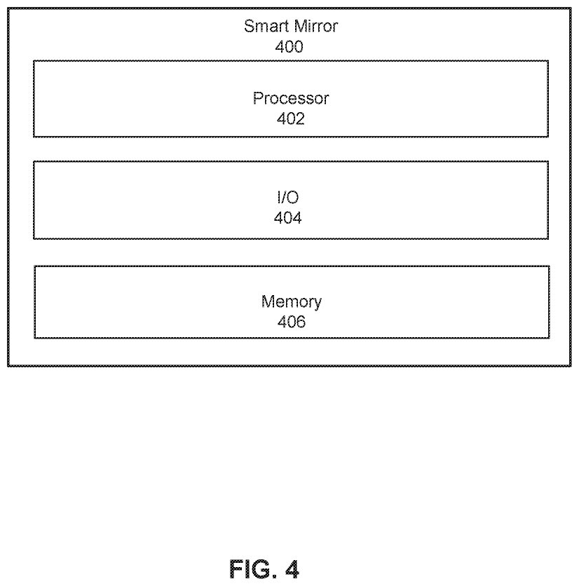

FIG. 4 shows an exemplary mirror device 400 for implementing embodiments consistent with the present disclosure. In an exemplary embodiment, mirror device 400 may correspond to smart mirror 104, 204.

In one embodiment, smart mirror 400 may include one or more processors 402, one or more input/output (I/O) devices 404, and one or more memories 406.

Memory 406 may include one or more storage devices configured to store instructions used by processor 402 to perform functions related to disclosed embodiments. For example, memory 406 may be configured with one or more software instructions, such as program(s) that may perform one or more operations when executed by processor 402. The disclosed embodiments are not limited to separate programs or computers configured to perform dedicated tasks. For example, memory 406 may include a single program that performs the functions of the smart mirror 400, or the program could comprise multiple programs. Additionally, processor 402 may execute one or more programs located remotely from smart mirror 400.

Components of 400 may function in substantially the same manner as corresponding components of 300.

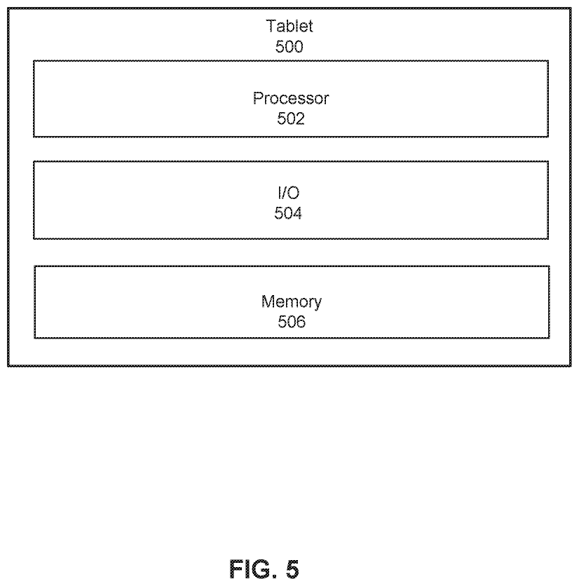

FIG. 5 shows an exemplary tablet for implementing embodiments consistent with the present disclosure. In an exemplary embodiment, tablet 500 may correspond to tablet 110, 210.

In one embodiment, tablet 500 may include one or more processors 502, one or more input/output (I/O) devices 504, and one or more memories 506.

Memory 506 may include one or more storage devices configured to store instructions used by processor 502 to perform functions related to disclosed embodiments. For example, memory 506 may be configured with one or more software instructions, such as program(s) that may perform one or more operations when executed by processor 502. The disclosed embodiments are not limited to separate programs or computers configured to perform dedicated tasks. For example, memory 506 may include a single program that performs the functions of the tablet 500, or the program could comprise multiple programs. Additionally, processor 502 may execute one or more programs located remotely from tablet 500.

Components of 500 may function in substantially the same manner as corresponding components of 300 and 400.

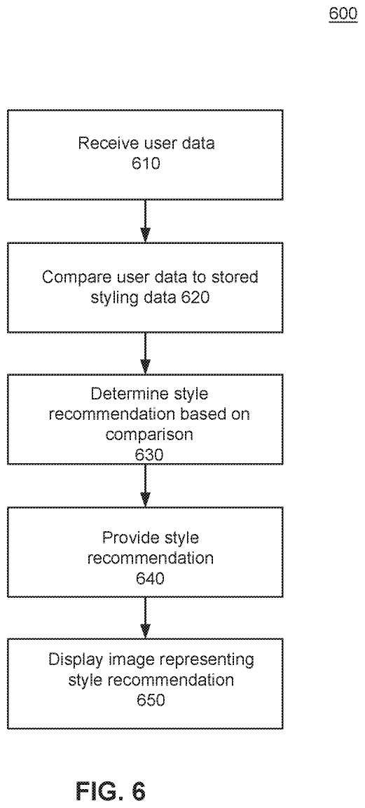

FIG. 6 is a flowchart of an exemplary process 600 for executing a style consultation. Process 600 is described herein as a style consultation using mirror unit 102, 202 and tablet 110, 210. For example, process 600 may be executed as a style consultation initiated by user 112, a stylist, that provides at least one style recommendation to user 117, a client.

In an exemplary embodiment, process 600 includes initiating a style consultation by receiving user data from user 117, for example a client (step 610). For example, user 112, for example a stylist, may initiate a style consultation by inputting information to mirror unit 102, 202 or tablet 110, 210. In an exemplary embodiment, user 112 may operate an I/O device associated with mirror device 104, 204 or tablet 110, 210, such as interface hardware. For example, user 112 may input information to smart mirror 104, 204 or tablet 110, 210 via a touch screen. In some embodiments, user 112 may operate smart mirror 104, 204 or tablet 110, 210 to execute a mobile application configured to facilitate the style consultation. User 112 may open the mobile application to initiate the style consultation. Additional instructions associated with the mobile application may be executed to prompt user 117 to input additional information as user data. For example, the additional instructions may prompt user 117 to provide lifestyle data by answering questions associated with personality types or lifestyle preferences using images as a guide. Questions may include choosing one of several holiday destinations or choosing one of a series of houses in which to live. User 117 may input data answering the questions. Additional instructions may also prompt user 117 to input their social media handles, providing data that includes user 117's online activity, physical location, age range, etc.

Mirror device 104, 204 may also output and display personalized content (e.g., travel destinations, fashion and beauty stories, celebrity news, architecture and interiors, sports, etc.) based on user 117's input data for user 117 to browse at any point during the style consultation process. Mirror device 104, 204 may output and display a visual representation (e.g., a pictorial grid) of user 117's personalized profile based on at least one of or some combination of user 117's various input data, including user 117's browsing activity. Additional instructions may also prompt user 117 to optionally change their personalized profile.

At any point during the style consultation, additional instructions associated with the mobile application may be executed to prompt user 117 to provide facial recognition as user data. For example, the additional instructions may prompt user 117 to face mirror unit 102, 202. Additional instructions may then prompt lighting system 106, 206 to detect at least one environmental light signal using sensors in a manner known in the art. Additional instructions may prompt image capture device 108, 208 to detect and capture at least one image of facial features and hair features of user 117 before, after, or simultaneously with prompting lighting system 106, 206 in a manner known in the art. Detected facial features of user 117 include at least one of user 117's face shape (e.g., oval, round, heart), skin tone (e.g., warm, cool), and/or eye color. Detected hair characteristics of user 117 include at least one of user 117's hair length, hair color, hair texture, and/or hair style. Image capture device 108, 208 may execute software instructions to transmit user data (i.e., detected facial features and hair characteristics of user 117) to lighting system 106, 206. Lighting system 106, 206 may receive the user data from image capture device 108, 208 and compare the received user data to the received environmental light signal. Lighting system 106, 206 may then determine the brightness that will result in the optimum image quality and highest accuracy in determining the user's facial features and hair characteristics and adjust the brightness according to the determination. Lighting system 106, 206 may transmit a notification to image capture device 108, 208 indicating that the optimum brightness has been set. Additional instructions to image capture device 108, 208 may be executed either automatically upon receiving the notification from lighting system 106, 206 and/or manually by prompting user 112 to execute the image capture via tablet 110, 210 or smart mirror 104, 204. The image captured by image device 108, 208 may be saved and stored as user data that includes facial features of user 117 (e.g., user C's face shape, skin tone, and/or eye color) and/or hair characteristics of user 117 (e.g., user 117's hair length, hair color, hair texture, and/or hair style). All user data obtained from user 117 may be saved and stored.

After user data has been received, the user data may be compared to stored styling data to continue the style consultation (step 620). Stored styling data may include any and all user data discussed in the disclosure that is saved from previous styling appointments. Stored styling data may also include any previous finished looks of user 117, which includes facial features and/or hair characteristics from user 117's previous finished looks. Stored styling data may also include facial features and hair characteristics of media personalities. Stored styling data may also include facial features and hair characteristics of previous style recommendations to user 117. User data may be edited by at least one of the users.

User data may be compared to the stored styling data to determine which of the stored styling data matches closest to the user data (step 630). This may be implemented using one or more data matching technologies known in the art. For example, the facial features and hair characteristics of user 117 are compared to the facial features and hair characteristics of the stored styling data to determine which of the stored styling data matches closest to user 117. At least one style recommendation may be output based on the comparison and determination of the user data to the stored styling data (step 640).

After the output of the at least one style recommendation, at least one image representing the at least one style recommendation may be displayed on at least one of smart mirror 104, 204 and/or tablet 110, 210 (step 650). For example, an image representing the at least one style recommendation may be an image of user 117 wearing the at least one style recommendation, which may be obtained using the image of user 117 obtained by image capture device 108, 208 and augmented reality technology in a manner known in the art. Another image representing the at least one style recommendation may be an image of a media personality wearing the at least one style recommendation, which may be obtained using a media personality who matches user 117 from the stored styling data and augmented reality technology in a manner known in the art. Any and all style recommendations and images representing the at least one style recommendation may also saved as stored styling data.

After user 117 chooses a style recommendation of their choice and user 112 applies the style recommendation to user 117, additional instructions associated with the mobile application may be executed to prompt user 117 or user 112 to prompt lighting system 106, 206 to detect at least one environmental light signal using sensors in a manner known in the art. Additional instructions may prompt image capture device 108, 208 to detect and capture at least one image of facial features and hair features of user 117 before, after, or simultaneously with prompting lighting system 106, 206 in a manner known in the art. Detected facial features of user 117 include at least one of user 117's face shape (e.g., oval, round, heart), skin tone (e.g., warm, cool), and/or eye color. Detected hair characteristics of user 117 include at least one of user 117's hair length, hair color, hair texture, and/or hair style. Image capture device 108, 208 may execute software instructions to transmit user data (i.e., detected facial features and hair characteristics of user 117) to lighting system 106, 206. Lighting system 106, 206 may receive the user data from image capture device 108, 208 and compare the received user data to the received environmental light signal. Lighting system 106, 206 may then determine the brightness that will result in the optimum image quality and highest accuracy in determining the user's facial features and hair characteristics and adjust the brightness according to the determination. Lighting system 106, 206 may transmit a notification to image capture device 108, 208 indicating that the optimum brightness has been set. Additional instructions to image capture device 108, 208 may be executed either automatically upon receiving the notification from lighting system 106, 206 and/or manually by prompting user 112 to execute the image capture via tablet 110, 210 or mirror 104, 204. The image captured by image device 108, 08 may be saved and stored as user 117's finished look, which may be saved as stored styling data that includes facial features of user 117 (e.g., user 117's face shape, skin tone, and/or eye color) and/or hair characteristics of user 117 (e.g., user 117's hair length, hair color, hair texture, and/or hair style).

All images captured by image capture device 108, 208 may include image data that may be associated with an instantaneous picture, a sequence of pictures, a continuous stream of images (e.g., video), etc. For example, each of the images captured by image capture device 108, 208 may be 360 degree images, such as a 360 degree still image, a sequence of images from regular degree intervals around a user, and/or a video rotation around a user. User 112 may be prompted by mirror unit 102, 202 and/or tablet 110, 210 to rotate the chair of user 117 to capture each image User 112 may further be prompted by mirror unit 102, 202 and/or tablet 110, 210 to adjust the speed of chair rotation (e.g., higher speed or lower speed) to improve the quality of the image(s) captured. The various embodiments of the 360 degree image(s) improves the quality and the accuracy of user data, stored styling data, style recommendations, etc.

In other embodiments, user 112 or 117 may share and/or send the at least one style recommendation to their personal network (e.g., friends) through social media, communications channels (e.g., e-mails, instant messaging, etc.), and/or social voting applications at any point during or after the style consultation. For example, user 117 may share and/or send the at least one style recommendation to their personal network through a social voting application to prompt their network to vote or express opinions on the at one least style recommendation.

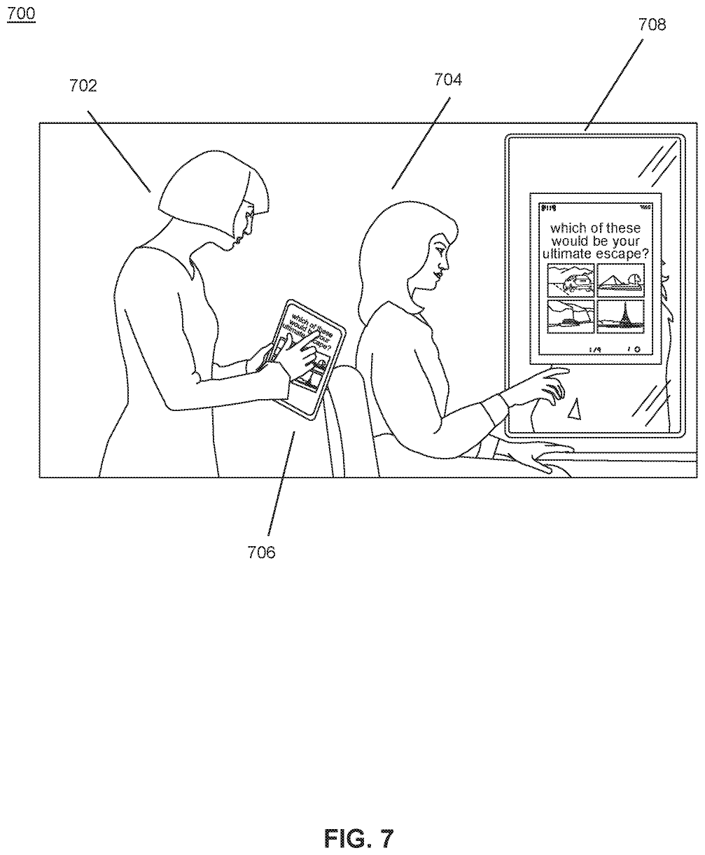

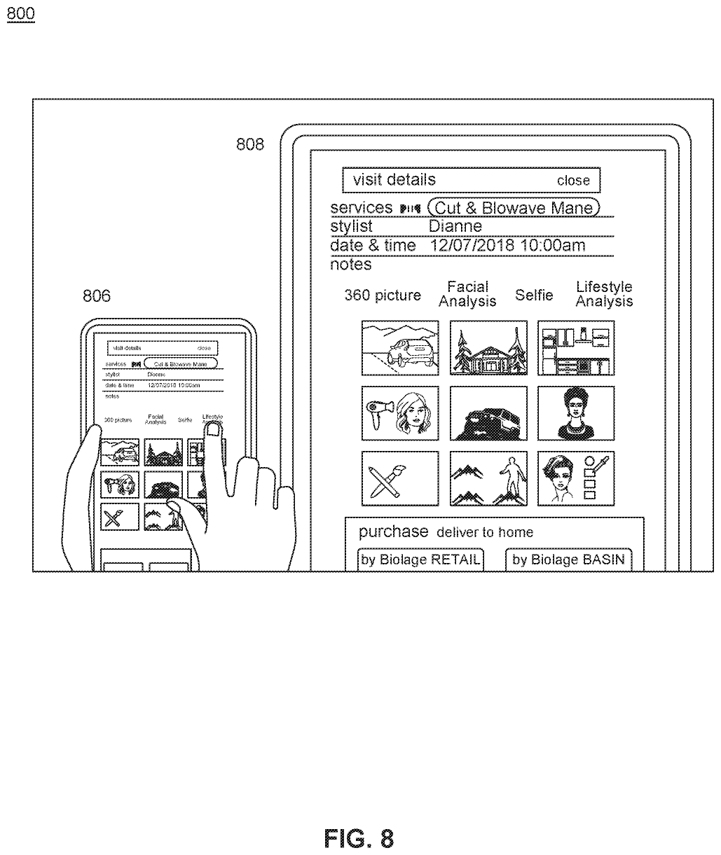

FIGS. 7 and 8 illustrate an exemplary smart mirror device system 700 and 800 consistent with the disclosed embodiments, where a user 702, who may be a stylist, may input information to a tablet 706, 806 via a touch screen to facilitate a style consultation for a user 704, who may be a client. User 704 may be prompted to input additional information to a smart mirror unit, 708, 808, via a touch screen. For example, the additional instructions may prompt user 704 to answer questions associated with personality types using images displayed on smart mirror 708, 808.

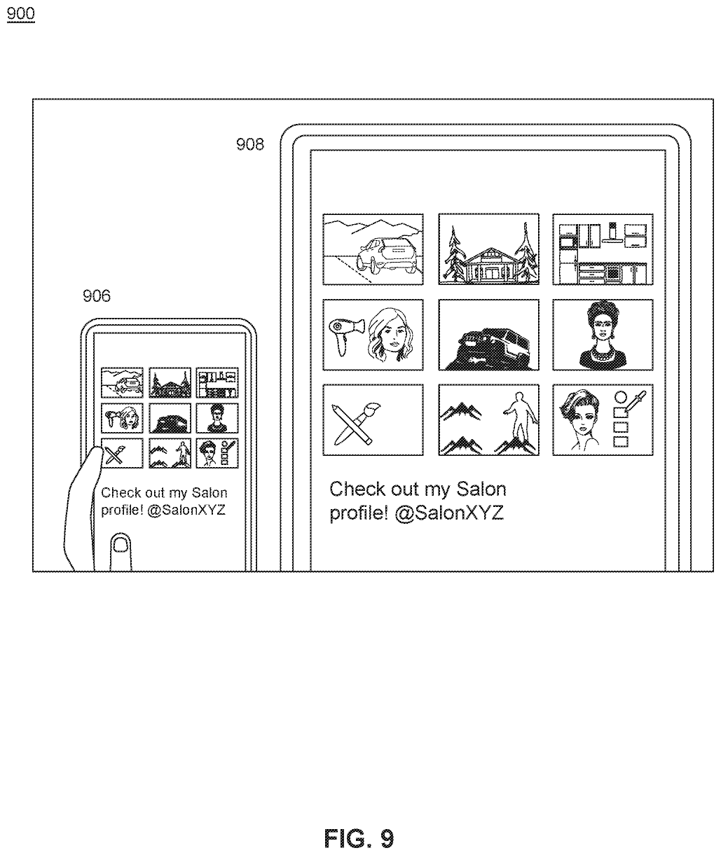

FIG. 9 illustrates an exemplary smart mirror device system 900, consistent with the disclosed embodiments, where user 704 may be prompted to share their personalized profile on social media and tag the salon by inputting information to a tablet 906 or a smart mirror unit 908 via a touch screen.

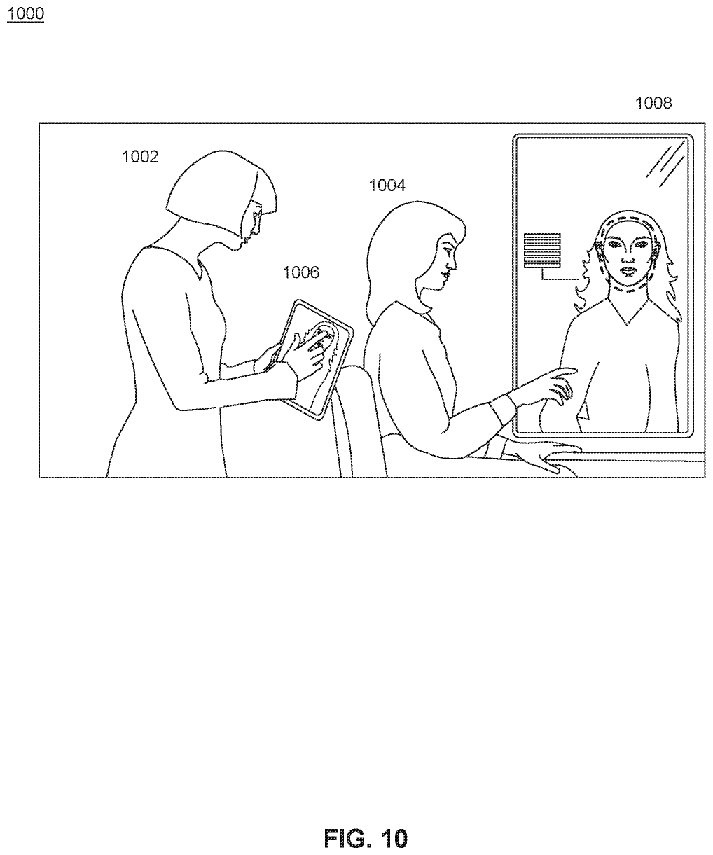

FIG. 10 illustrates an exemplary smart mirror device system 1000 consistent with the disclosed embodiments, where a user 1002, who may be a stylist, may input information to a tablet 1006 via a touch screen to facilitate obtaining facial recognition data from a user 1004, who may be a client. A smart mirror unit 1008 may include a hidden image capture device and lighting system. User 1004 may be prompted to face a smart mirror unit 1008 to provide facial recognition data.

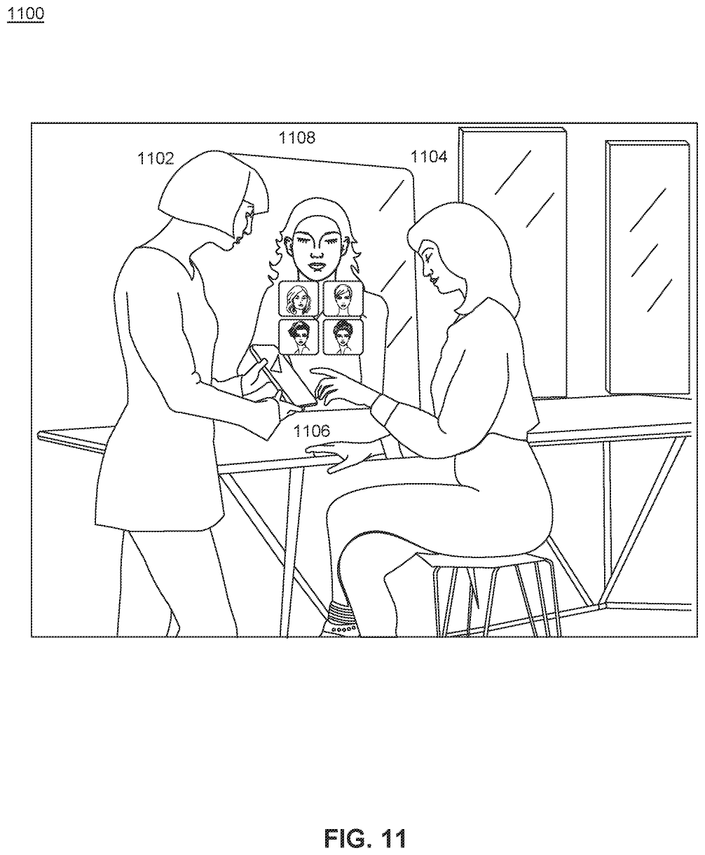

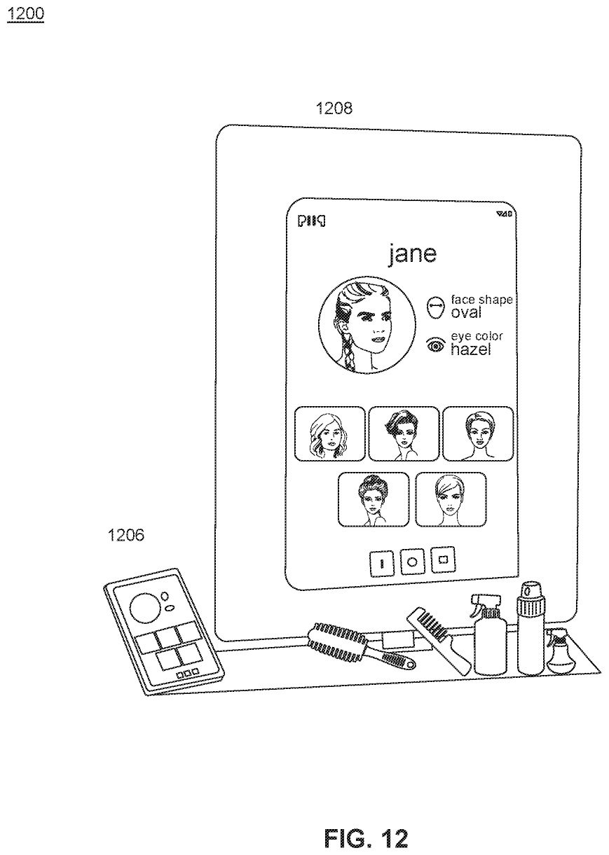

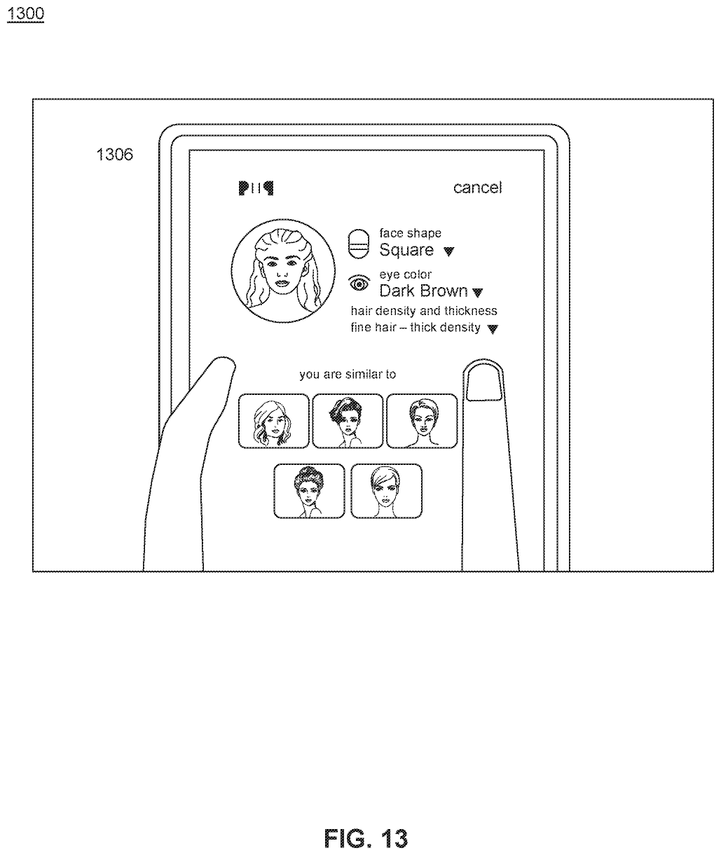

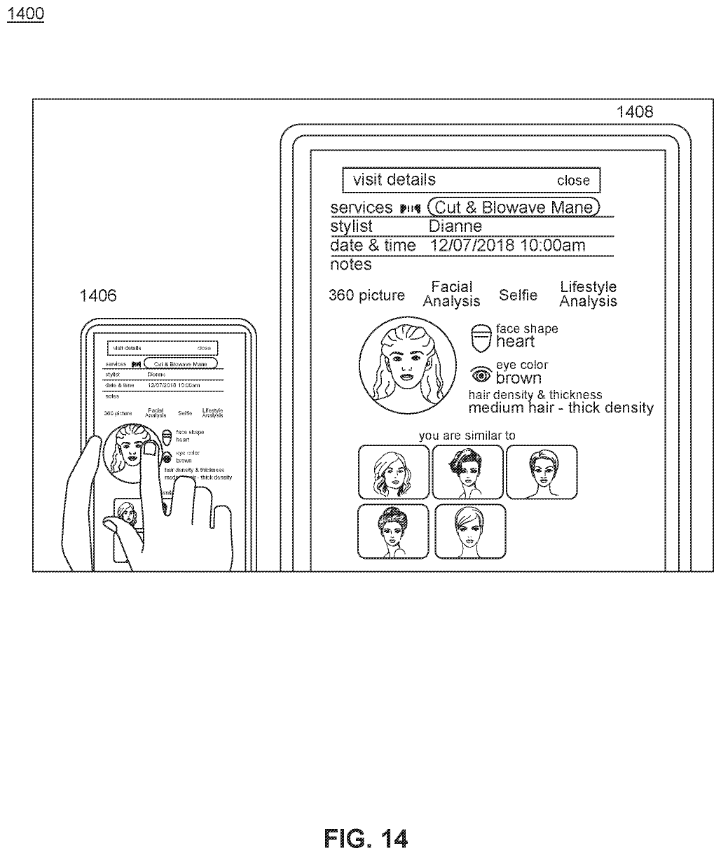

FIGS. 11, 12, 13, and 14 illustrate exemplary smart mirror device systems 1100, 1200, 1300, 1400 consistent with the disclosed embodiments, where a user 1102, who may be a stylist, may initialize a comparison and determination of at least one match between user data and stored styling data. A user 1104, who may be a client may view outputted style recommendations based on the comparison and determination on at least one of tablet 1106, 1206, 1306, 1406 and/or a smart mirror unit 1108, 1208, 1408.

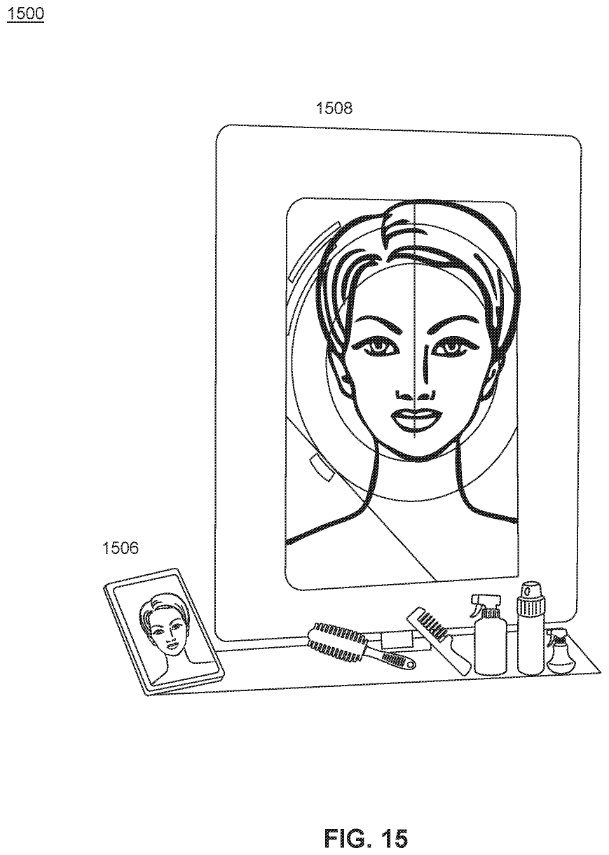

FIG. 15 illustrates an exemplary smart mirror device system 1500 consistent with the disclosed embodiments, where at least one of tablet 1506 and/or a smart mirror unit 1508 may display at least one image representing the at least one style recommendation.

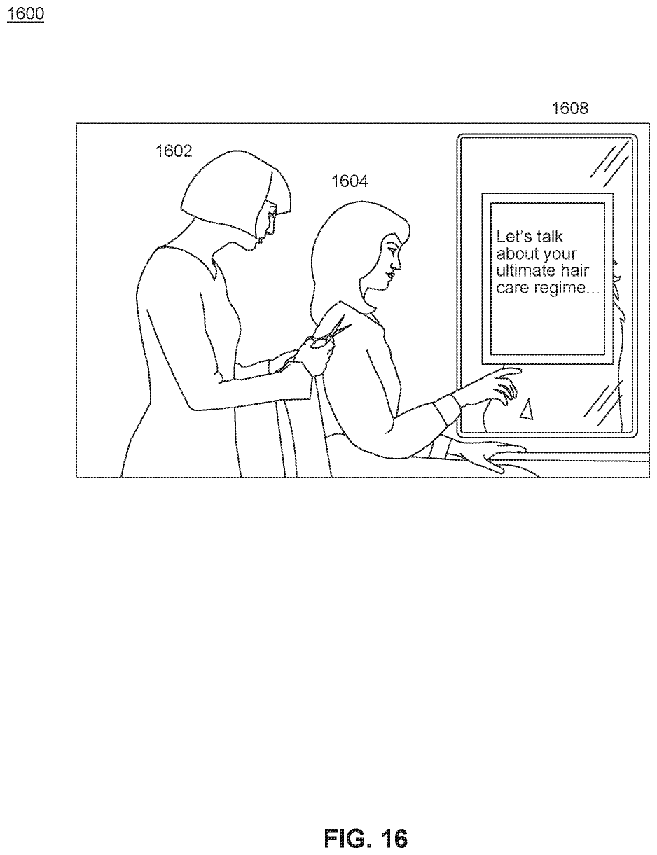

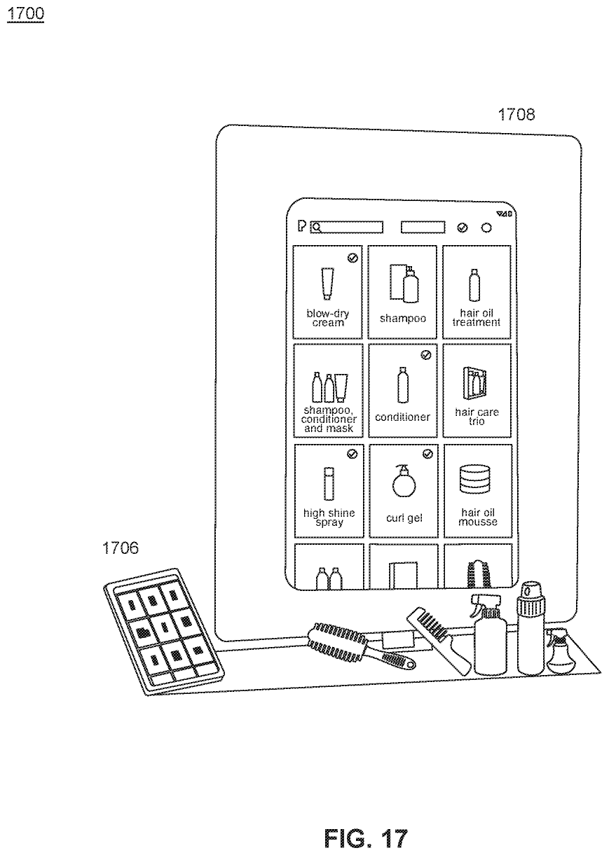

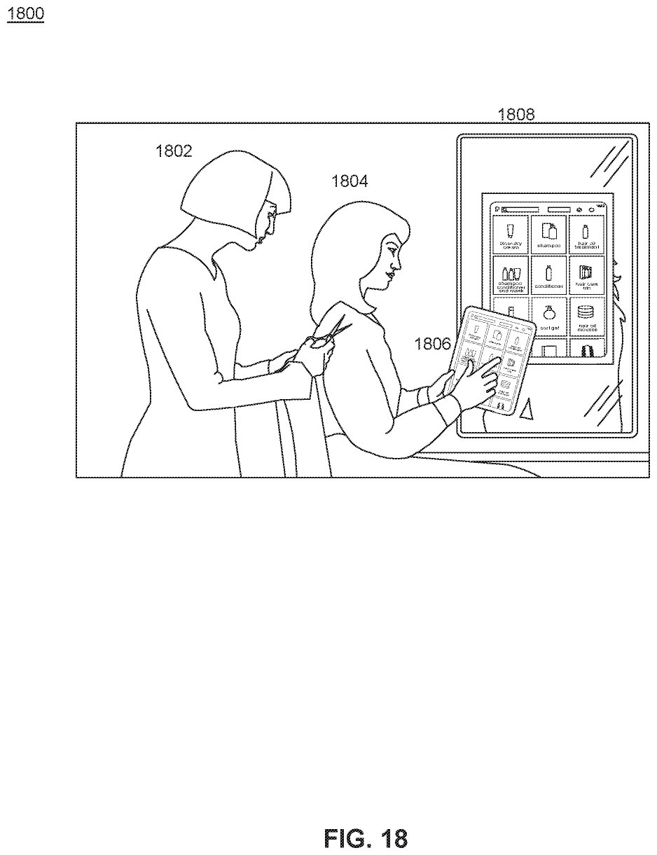

FIGS. 16, 17, and 18 illustrate exemplary smart mirror device systems 1600, 1700, 1800 consistent with the disclosed embodiments, where a user 1602, 1802, who may be a stylist, may use at least one of tablet 1706, 1806 and/or a smart mirror unit 1608, 1708, 1808 to initialize and display a prompt offering various hair care products to a user 1604, 1804, who may be a client, that may be based on the at least one style recommendation. User 1604, 1804 may browse the offered hair care products on at least one of tablet 1706, 1806 and smart mirror unit 1608, 1708, 1808 at any point before, during, or after the style consultation.

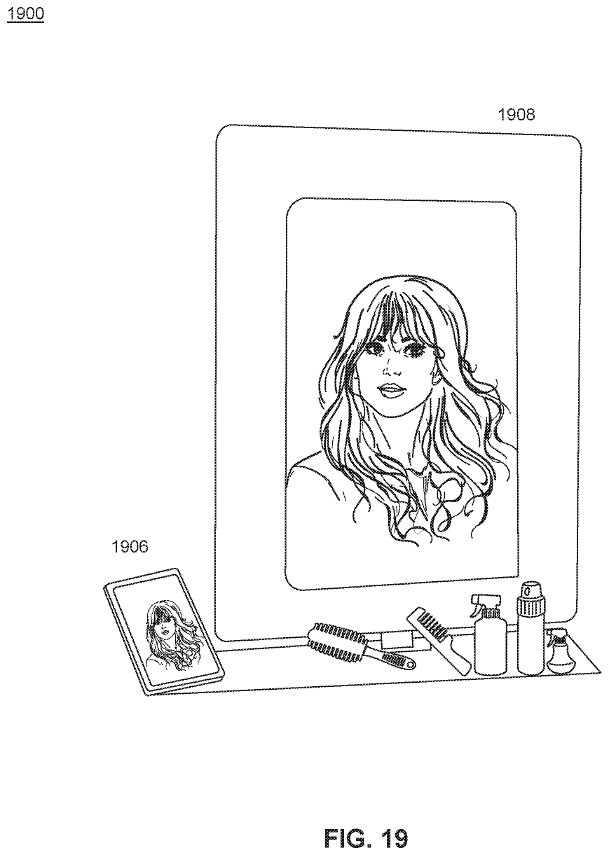

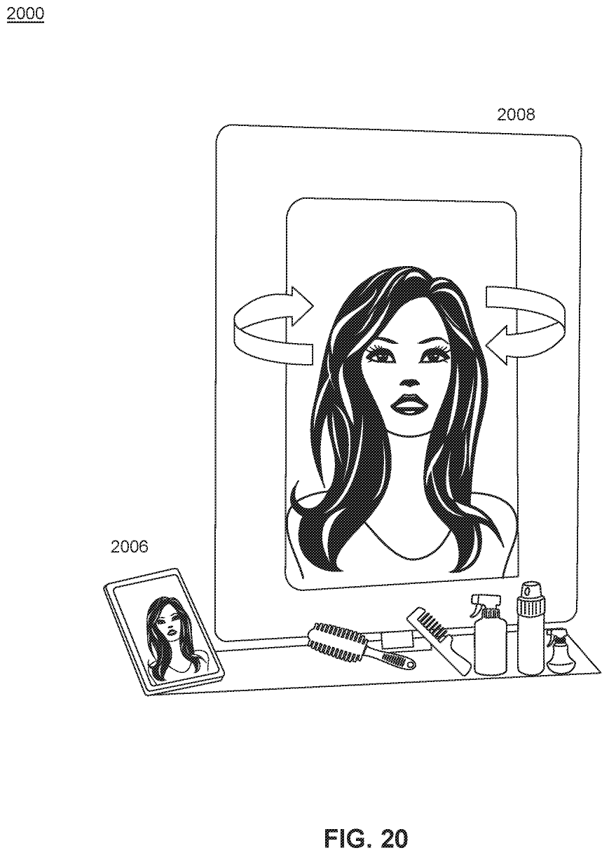

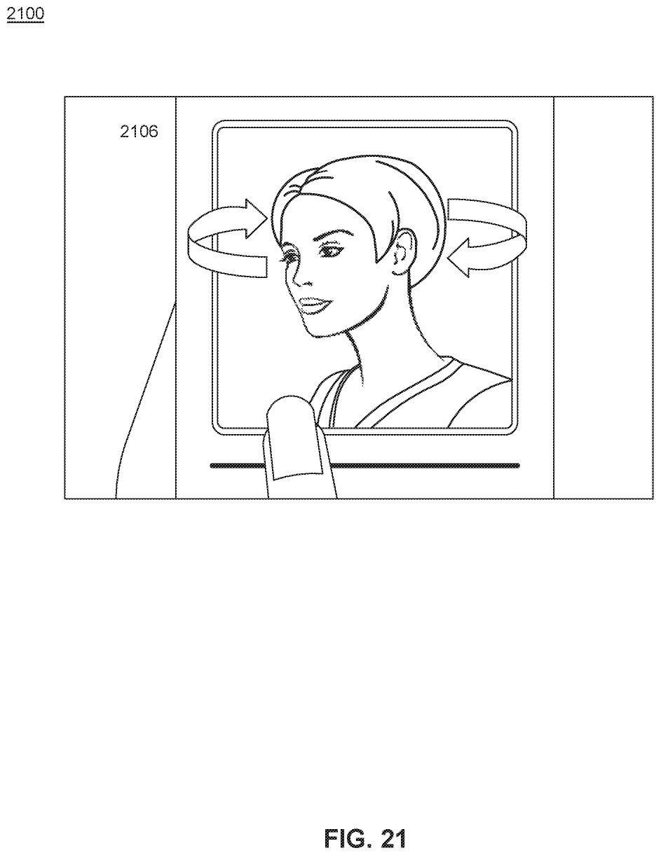

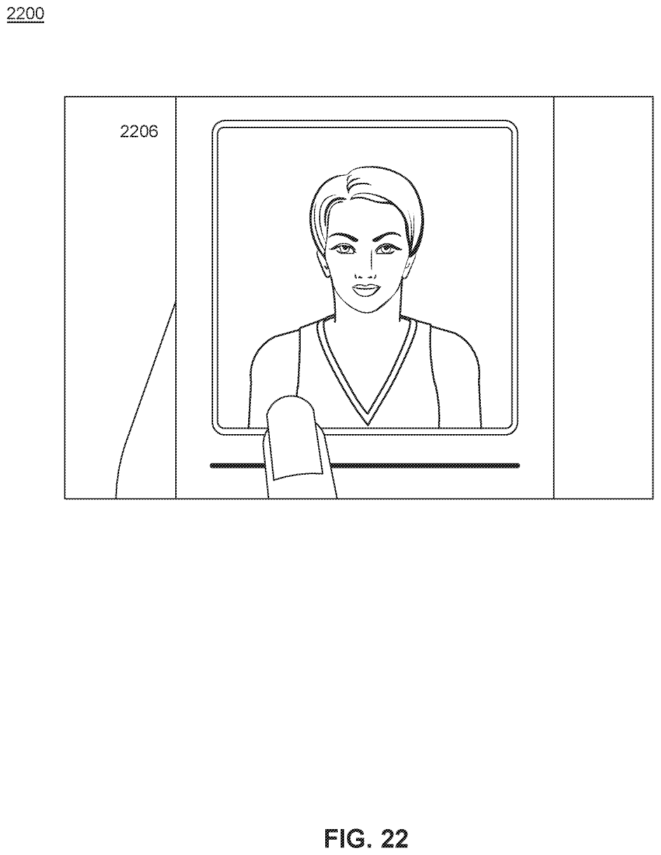

FIGS. 19, 20, 21, and 22 illustrate exemplary smart mirror device systems 1900, 2000, 2100, 2200 consistent with the disclosed embodiments, where a client's finished look can be captured by the image capture device as a 360 degree image and displayed on at least one of tablet 1906, 2006, 2106, 2206 and/or a smart mirror unit 1908, 2008.

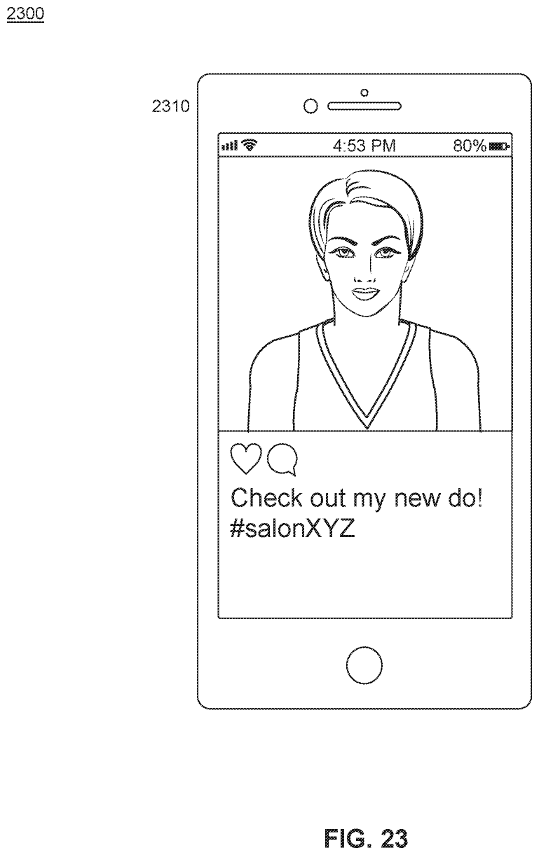

FIG. 23 illustrates an exemplary smart mirror device system 2300 consistent with the disclosed embodiments, where a client may share their finished look on social media using at least one of a tablet, smart mirror unit, and/or a client's personal smart device 2310.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Further, while two users operating two devices may be primarily described, it should be understood that three or more users operating three or more devices may be used in similar systems and processes to complete style consultations between the three or more users.

Computer programs based on the written description and methods of this specification may be within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A computer-implemented system, comprising:
a memory device storing a set of instructions; and
at least one processor executing the set of instructions to perform a method, the method comprising:
receiving user data describing a user, where the user data includes at least one of:
a selection of images from a provided image set,
social media data, or
facial recognition data;
comparing the user data to stored styling data;
determining that the user data matches the stored styling data;
outputting at least one style recommendation based on the matching stored styling data; and
displaying an image representing the at least one style recommendation on a display.

2. The system of claim 1, wherein the image representing the at least one style recommendation is saved as stored styling data.

3. The system of claim 1, wherein the display is a smart mirror.

4. The system of claim 1, where the stored styling data includes a suggested hair length, hair color, hair texture, and hair style from at least one of:
a previous style recommendation from one of the user's previous appointments;
a previous finished look of the user; or
media personalities with facial features or skin tones similar to that of the user.

5. The system of claim 1, where the user data describing the user further includes at least one of the user's online activity, physical location, or age range.

6. The system of claim 5, where the user data is used to curate a personalized profile of the user and the personalized profile is saved as stored styling data.

7. The system of claim 5, where:
the user is prompted to answer questions based on user data;
the user's answers to the questions are used to curate a personalized profile of the user; and
where the personalized profile is saved as stored styling data.

8. The system of claim 5, where an image capture capability obtains the facial recognition data of the user and the facial recognition data includes the user's face shape, skin tone, and eye color obtained by a smart mirror.

9. The system of claim 1, where an image capture capability obtains a 360 degree image of a finished look of the user and the 360 degree image is saved as stored styling data.

10. The system of claim 1, where an image capture capability obtains a hair length, hair color, hair texture, and hair style of a finished look of the user and the hair length, hair color, hair texture, and hair style of the finished look are saved as stored styling data.

11. The system of claim 1, where the image representing the at least one style recommendation is an image of the user wearing the at least one style recommendation and the display is a smart mirror that uses augmented reality technology.

12. The system of claim 11, where the at least one style recommendation includes a hair style of a media personality.

13. The system of claim 1, where the image representing the at least one style recommendation is a media personality, with facial features similar to those of the user, wearing the at least one style recommendation and the display is a smart mirror that uses augmented reality technology.

14. The system of claim 1, where the at least one style recommendation includes at least one suggested hair care product.

15. The system of claim 1, where the social media data includes preference data received from social contacts of the user.

16. A smart mirror device comprising:
a mirror unit, the mirror unit comprising:
a mirror;
a lighting system configured to provide consistent downlighting for capturing an image of a user; and
a camera at a location on the mirror unit; and
a tablet connected to the mirror unit.

17. The smart mirror device of claim 16, the mirror unit further comprising a display unit configured to display an image on or through the mirror.

18. The smart mirror device of claim 17, where the tablet is configured to control the image displayed on or through the mirror, where the image may be at least one of:
a selection of images from a provided image set,
a prompt to provide social media data,
a prompt to provide facial recognition data, and
a selection of haircare products.

19. The smart mirror device of claim 18, where the mirror includes a touch screen, which is configured to allow a user to select images from the selection of images, provide social media data, provide facial feature data, or select at least one haircare product from the selection of haircare products.

20. The smart mirror device of claim 17, where the lighting system and the camera are configured to capture facial recognition data.

21. The smart mirror device of claim 16, where the lighting system is fixed.

22. The smart mirror device of claim 16, where the camera is hidden at a fixed location.

23. The smart mirror device of claim 16, where the tablet is physically connected to the mirror unit with a cable.

24. A method for providing at least one style recommendation, the method comprising:
receiving user data describing a user, where the user data includes at least one of:
a selection of images from a provided image set,
social media data, or
facial recognition data;
comparing the user data to stored styling data;
determining that the user data matches the stored styling data;
outputting at least one style recommendation based on the matching stored styling data; and
displaying an image representing the at least one style recommendation on a display.

25. The system of claim 24, where the social media data includes preference data received from social contacts of the user.

26. A non-transitory computer-readable medium having stored instructions, which when executed, cause a processor to provide at least one style recommendation by:
receiving user data describing a user, where the user data includes at least one of:
a selection of images from a provided image set,
social media data, or
facial recognition data;
comparing the user data to stored styling data;
determining that the user data matches the stored styling data;
outputting at least one style recommendation based on the matching stored styling data; and
displaying an image representing the at least one style recommendation on a display.
